(19) United States
(12) Patent Application Publication
(10) Pub. No.: US 2026/0171075 A1
(43) Pub. Date: Jun. 18, 2026

(54) SYSTEMS AND METHODS FOR EMULATING A VOICE BASED ON A SPEECH PROMPT

(71) Applicants: Constructor Technology AG, Schaffhausen (CH); Constructor Education and Research Genossenschaft, Schaffhausen (CH)

(72) Inventors: Andrey ADASHCIK, Istanbul (TR); Dmitrii OBUKHOV, Castelló de la Plana (ES); Marcel de KORTE, Stockholm (SE); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 18/982,292

(22) Filed: Dec. 16, 2024

(51) Int. Cl. G10L 13/10

(52) U.S. Cl. CPC G10L 13/10; G10L 2013/105

(57) ABSTRACT

A speech engine inputs, into an encoder-decoder machine learning (ML) model, an input text and an audio clip including a voice reciting a speech, wherein the encoder-decoder ML model is trained to generate acoustic features representing an emulation of the voice reciting the input text. The encoder-decoder ML model is configured to: receive a phoneme sequence of the input text; predict a duration of each phoneme in the phoneme sequence; predict a pitch and an energy for reciting the input text based on the partially masked acoustic representations obtained from the audio clip; and generate acoustic features based on (1) the duration of phoneme in the phoneme sequence, (2) the predicted pitch, and (3) the predicted energy The speech engine inputs the generated acoustic features into a vocoder model configured to generate an output waveform representing the input text being recited by the emulation of the voice.

### FIELD OF TECHNOLOGY

The present disclosure relates to the field of speech generation, and, more specifically, to systems and methods for emulating a voice based on a speech prompt.

### BACKGROUND

Modern voice-cloning approaches are able to recreate the voice of a person with only small amounts of data. Typically, voice cloning is accomplished by fine-tuning a well-trained foundation model to adjust to the characteristics of the target speaker. However, this approach still takes time to fine-tune and involves the creation of a separate model for every speaker.

### SUMMARY

The present disclosure describes an approach for reproducing a voice by taking a speech prompt of a few seconds and learning how to continue speaking in a similar style and with the same speaker identity. The ability to do this is obtained by extracting the pitch, energy, duration, and acoustic features from the speech prompt. This information is put into a transformer architecture configured to generate the target speech with similar acoustic characteristics by using a self-attention mechanism. By supplying this information to the target sentence, alongside the phoneme input representation, the disclosed model is altogether able to synthesize speech of high-quality that sounds similar to the speaking style of the speech prompt.

In one exemplary aspect, the techniques described herein relate to a method for emulating a voice based on a speech prompt, including: inputting, into an encoder-decoder machine learning (ML) model, an input text and an audio clip including a voice reciting a speech, wherein the encoder-decoder ML model is trained to generate acoustic features representing an emulation of the voice reciting the input text; wherein the encoder-decoder ML model is configured to: receive a phoneme sequence of the input text; predict a duration of each phoneme in the phoneme sequence; predict a pitch and an energy for reciting the input text based on partially masked acoustic representations obtained from the audio clip; generate acoustic features based on (1) the duration of phoneme in the phoneme sequence, (2) the predicted pitch, and (3) the predicted energy; inputting the generated acoustic features into a vocoder model configured to generate an output waveform representing the input text being recited by the emulation of the voice.

In some aspects, the techniques described herein relate to a method, wherein the audio clip is a less than a minute in duration.

In some aspects, the techniques described herein relate to a method, wherein the encoder-decoder ML model is further configured to generate phoneme embeddings of the phoneme sequence.

In some aspects, the techniques described herein relate to a method, wherein the encoder-decoder ML model is further configured to input the phoneme embeddings into an encoder of the encoder-decoder ML model, wherein the encoder is configured to: predict the duration of the each phoneme in the phoneme sequence; and upsample representations of individual phonemes in the phoneme embeddings based on the predicted duration.

In some aspects, the techniques described herein relate to a method, wherein the encoder-decoder ML model is further configured to: concatenate the audio clip with the upsampled representations to generate a first intermediate output; and predict the pitch for reciting the input text based on the first intermediate output.

In some aspects, the techniques described herein relate to a method, wherein the encoder-decoder ML model is further configured to: add the pitch to the first intermediate output to generate a second intermediate output; and predict the energy for reciting the input text based on the second intermediate output.

In some aspects, the techniques described herein relate to a method, wherein the encoder-decoder ML model is further configured to: add the energy to the second intermediate output to generate a third intermediate output; and input the third intermediate output in a decoder of the encoder-decoder ML model, wherein the decoder generates the acoustic features.

In some aspects, the techniques described herein relate to a method, wherein the encoder-decoder ML model is trained using masked and unmasked speech audio clips, wherein the encoder-decoder ML model learns to emulate a detected voice in an unmasked portion and executes an emulated voice during a masked portion.

It should be noted that the methods described above may be implemented in a system comprising a hardware processor. Alternatively, the methods may be implemented using computer executable instructions of a non-transitory computer readable medium.

In some aspects, the techniques described herein relate to a system for emulating a voice based on a speech prompt, including: at least one memory; and at least one hardware processor coupled with the at least one memory and configured, individually or in combination, to: input, into an encoder-decoder machine learning (ML) model, an input text and an audio clip including a voice reciting a speech, wherein the encoder-decoder ML model is trained to generate acoustic features representing an emulation of the voice reciting the input text; wherein the encoder-decoder ML model is configured to: receive a phoneme sequence of the input text; predict a duration of each phoneme in the phoneme sequence; predict a pitch and an energy for reciting the input text based on partially masked acoustic representations obtained from the audio clip; generate acoustic features based on (1) the duration of phoneme in the phoneme sequence, (2) the predicted pitch, and (3) the predicted energy; input the generated acoustic features into a vocoder model configured to generate an output waveform representing the input text being recited by the emulation of the voice.

In some aspects, the techniques described herein relate to a non-transitory computer readable medium storing thereon computer executable instructions for emulating a voice based on a speech prompt, including instructions for: inputting, into an encoder-decoder machine learning (ML) model, an input text and an audio clip including a voice reciting a speech, wherein the encoder-decoder ML model is trained to generate acoustic features representing an emulation of the voice reciting the input text; wherein the encoder-decoder ML model is configured to: receive a phoneme sequence of the input text; predict a duration of each phoneme in the phoneme sequence; predict a pitch and an energy for reciting the input text based on partially masked acoustic representations obtained from the audio clip; generate acoustic features based on (1) the duration of phoneme in the phoneme sequence, (2) the predicted pitch, and (3) the predicted energy; inputting the generated acoustic features into a vocoder model configured to generate an output waveform representing the input text being recited by the emulation of the voice.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for emulating a voice based on a speech prompt.

FIG. 2 is a diagram of a partially masked speech prompt.

FIG. 3 illustrates a flow diagram of a method for emulating a voice based on a speech prompt.

FIG. 4 presents an example of a general-purpose computer system on which aspects of the present disclosure can be implemented.

### DETAILED DESCRIPTION

Exemplary aspects are described herein in the context of a system, method, and computer program product for emulating a voice based on a speech prompt. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

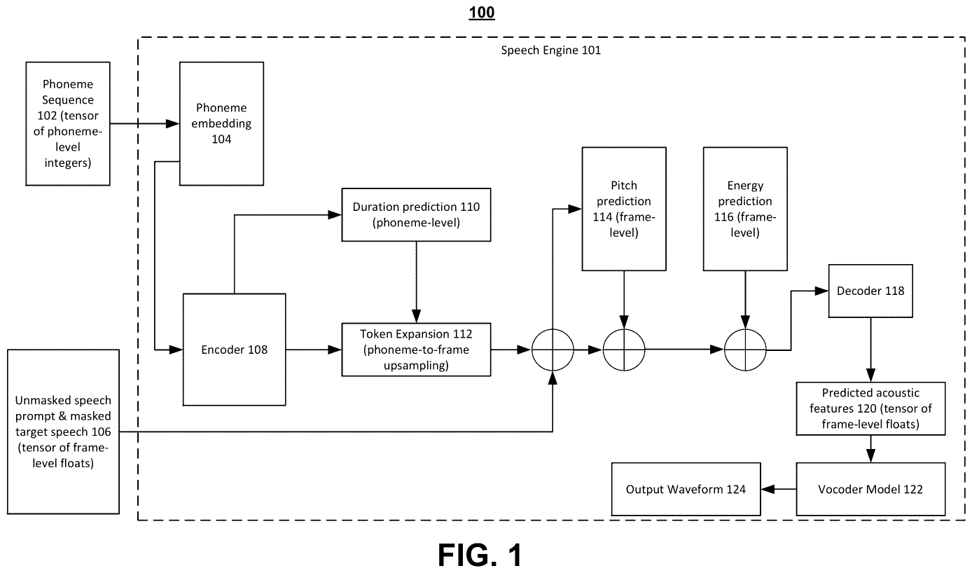

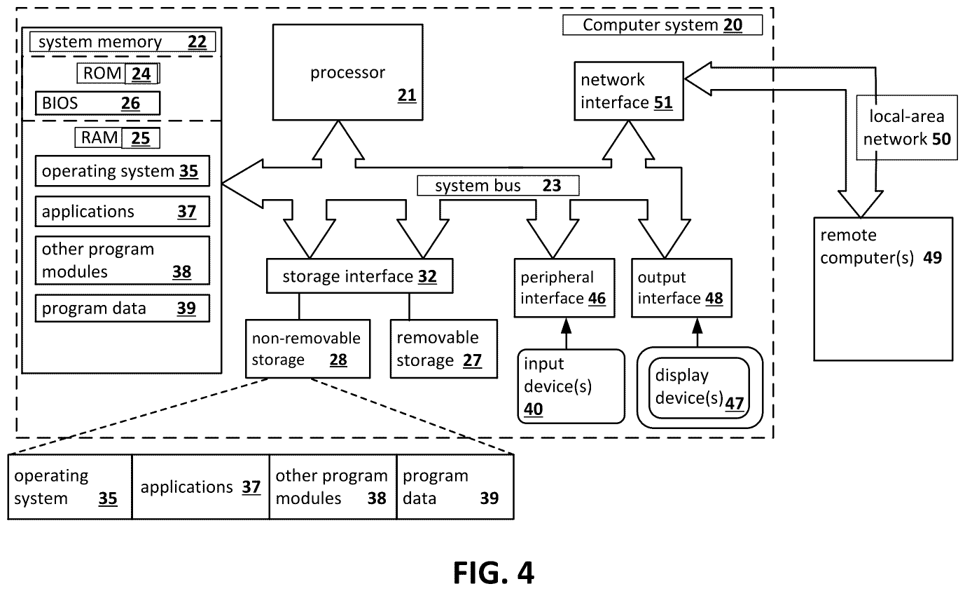

FIG. 1 is a block diagram illustrating system 100 for emulating a voice based on a speech prompt. Suppose that an input text is provided to speech engine 101, which may be a software module executed by a computer system 20 (described in FIG. 4). The input text may be converted into phoneme sequence 102, which is a tensor of phoneme-level integers. For example, if a word sequence in the input text represents the phrase “we are happy,” the corresponding phoneme sequence 102 (using a phonemic transcription system such as ARPAbet) represents “W IY AA R HH AE P IY.”

System 100 then determines phoneme embedding 104 based on phoneme sequence 102. Phoneme embedding 104 is a numerical representation of phonemes that capture their phonetic properties and relationships in a continuous vector space.

To generate phoneme embeddings for the sequence “we are happy,” for example, system 100 may use a pre-trained phoneme embedding model to map each phoneme to its corresponding embedding vector.

A hypothetical example of phoneme embedding 108 is shown below.
   |Phoneme|Embedding (Example)|
   |---------|--------------------------------|
   |W|[0.12, −0.34, 0.56, . . . , 0.78]|
   |IY|[0.45, −0.67, 0.89, . . . , 0.12]|
   |AA|[0.23, −0.45, 0.67, . . . , 0.34]|
   |R|[0.56, −0.78, 0.12, . . . , 0.45]|
   |HH|[0.34, −0.56, 0.78, . . . , 0.67]|
   |AE|[0.67, −0.89, 0.23, . . . , 0.78]|
   |P|[0.78, −0.12, 0.34, . . . , 0.89]|

In this matrix, each row corresponds to the embedding of a phoneme. For example, if each phoneme embedding is a 256-dimensional vector, the resulting matrix for the sequence would be of size (8*256). In some aspects, the phoneme embedding model may be TensorFlowTTS (a library that provides pre-trained models for text-to-speech synthesis) or ESPnet (an end-to-end speech processing toolkit that includes models for speech recognition and synthesis).

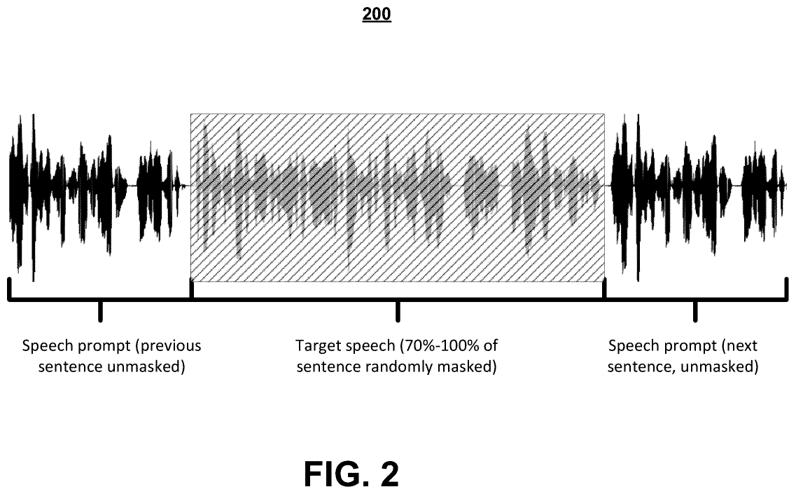

Unmasked speech prompt and masked target speech 106 is a tensor of frame-level floats. The input text provided to speech engine 101 represents the text recited in speech 106. However, certain parts of speech 106 are masked. For example, FIG. 2 is a diagram of speech prompt 200. As can be seen, a first portion of the audio clip is unmasked (e.g., a sentence), a second portion is masked (e.g., comprising the speech that the system 100 should produce), and a third portion after the masked portion is unmasked (e.g., another sentence). The input text corresponding to phoneme sequence 102 includes words recited in the speech prompt. For example, the entirety of the input text may be “we are happy that the war is over. It is time for peace.” The first portion in the speech prompt may correspond to the phrase “we are happy.” The second portion may correspond to the phrase “that the war is over.” The third portion may correspond to “it is time for peace.”

An objective is for system 100 to produce acoustic features for the words associated with the masked portion (i.e., “that the war is over”) that match the acoustic features of the actual masked speech in speech prompt 200.

Phoneme embedding 104 is input into an encoder-decoder machine learning model. In particular, encoder 108 receives phoneme embedding 104 and determines a duration prediction. The duration prediction represents the length of each phoneme in the expected speech based on the speed at which the talker speaks in speech 106. For example, if the frame rate of speech 106 is 50 frames per second (i.e., 20 ms), the task of encoder 108 is to predict how many frames each phoneme should take.

Encoder 108 is configured to perform token expansion 112 based on the predicted duration. Token expansion 112 is an upsampling of phonemes to a frame level. During upsampling, encoder 108 repeats the encoded representation A, x times (where x is predicted by the duration predictor for each individual encoded representation). For example, if there are three phonemes and the duration prediction is [2, 4, 3], then the first encoded representation is repeated twice, the second four times, and the third one three times.

During the training procedure, an attention module makes a soft-attention prediction between encoded phonemes and speech features. This is converted into a “hard alignment” where the attention for each frame is allocated to a particular encoded phoneme.

Subsequently, speech engine 101 performs concatenation between speech 106 and the frame-level embeddings resulting from token expansion 112. The concatenated value can be referred to as enc_out_expanded. On a technical level, the code for this concatenation may be:
mixed_enc_out_expanded=torch.cat((enc_out_expanded, masked_input_acoustics.permute(0, 2, 1)), 2)
enc_out_expanded=self.drop(self.masked_speech_emb(mixed_enc_out_expanded))

The expanded encoder outputs are concatenated with the masked input acoustics (permutation in the code is not relevant here). Then, this is put through self.masked_speech_emb, which is a linear layer that casts this back to the dimension of enc_out_expanded (since now the dimension is enc_out_expanded+masked_input_acoustics). Finally, dropout is applied.

This concatenated output is used by encoder 108 to produce a pitch prediction 114, which is a tensor of a float value on a frame-level. Speech engine 101 adds pitch prediction 114 to enc_out_expanded to yield pitch_enc_out_added. Encoder 108 then generates an energy prediction 116 based on pitch_enc_out_added. It should be noted that a target duration, energy, and pitch corresponding to the unmasked speech prompt is given to the system as a training input. Accordingly, speech engine 101 generates duration prediction 110, pitch prediction 114, and energy prediction 116 to match said target values. Energy prediction 116 and pitch_enc_out_added are added together and input into decoder 118.

With this input, decoder 118 generates predicted acoustic features 120 (e.g., a tensor of frame-level floats) such as a Mel spectrogram. In some aspects, decoder 118 comprises transformer layers. The output of decoder 118 may be input into a vocoder model 122 to generate output waveform 124 (e.g., speech). When successfully trained, system 100 should produce output waveform 124 such that a difference between output waveform 124 and the masked portion in speech prompt 200 is less than a threshold difference.

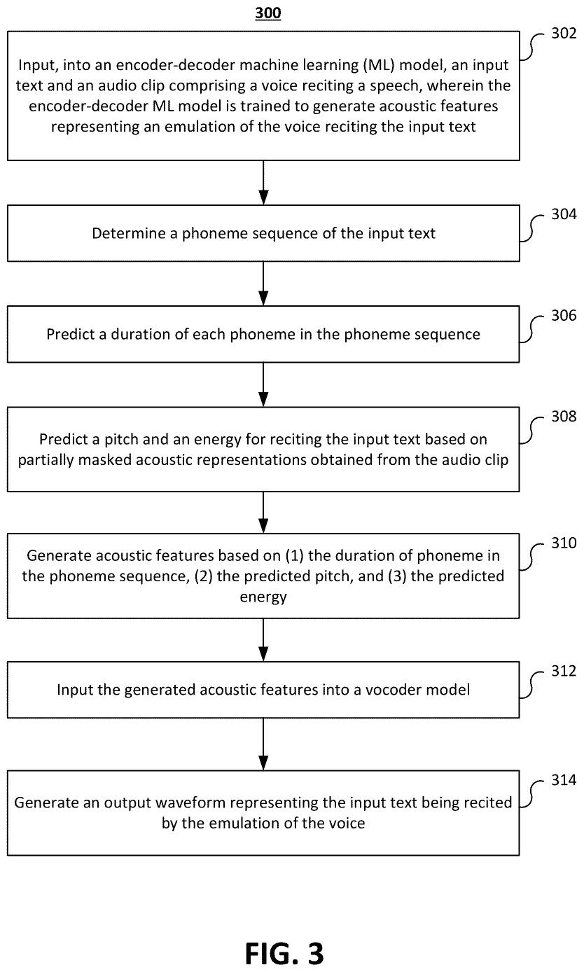

FIG. 3 illustrates a flow diagram of method 300 for emulating a voice based on a speech prompt. At 302, speech engine 101 inputs, into an encoder-decoder machine learning (ML) model (comprising encoder 108 and decoder 118), an input text and an audio clip (e.g., speech 106) comprising a voice reciting a speech. The encoder-decoder ML model is trained to generate acoustic features (e.g., features 120) representing an emulation of the voice reciting the input text.

In some aspects, the audio clip is a less than a minute in duration (e.g., 10 seconds).

In some aspects, the encoder-decoder ML model is trained using masked and unmasked speech audio clips, wherein the encoder-decoder ML model learns to emulate a detected voice in an unmasked portion and executes an emulated voice during a masked portion. For example, referring to speech prompt 200, the encoder-decoder ML model may extract features from an unmasked portion and attempt to replicate the voice based on the extracted features in order to recite the text in the masked portion. The output generated by the encoder-decoder ML model may then be compared against the masked portion to train the encoder-decoder ML model and improve its emulation capabilities.

At 302, suppose that the input text includes 2 sentences. The accompanying audio clip may feature a voice reciting the first sentence only. The speech engine ultimately generates an audio clip that recites the second sentence with the same vocal characteristics as the voice in the audio clip.

At 304, speech engine 101 utilizes a phoneme generation model to determine a phoneme sequence of the input text. In some aspects, a phoneme embedding model may further generate phoneme embeddings of the phoneme sequence. The embeddings are received by the encoder-decoder ML model.

In some aspects, the encoder-decoder ML model is further configured to input the phoneme embeddings into an encoder of the encoder-decoder ML model, wherein the encoder is configured to: predict the duration of the each phoneme in the phoneme sequence (described further in step 306); and upsample representations of individual phonemes in the phoneme embeddings based on the predicted duration.

At 306, the encoder-decoder ML model predicts a duration of each phoneme in the phoneme sequence. For example, the encoder-decoder ML model extracts the durations of phonemes in the first sentence. Based on these extracted durations, the encoder-decoder ML model predicts the durations of phonemes in the second sentence. It should be noted that during the training stage of the encoder-decoder ML model, the masked inputs further provide target durations for each phoneme. Accordingly, the encoder-decoder ML model is pre-trained (i.e., the loss between its training predictions and target predictions have been optimized) and the predicted durations for the arbitrary input provided at 302 are expected to be accurate.

At 308, the encoder-decoder ML model predicts a pitch and an energy for reciting the input text based on partially masked acoustic representations obtained from the audio clip. Similar to step 306, the pitch and energy of the voice are extracted from the recitation of the first sentence and are expected to remain consistent if the second sentence were recited. For instance, consider an audio clip where the speaker's voice has a high pitch and energetic tone while expressing excitement in the first sentence, such as “I can't believe we won the championship!” The encoder-decoder model extracts these features—high pitch and energy—from the recitation of this sentence. When tasked with synthesizing a subsequent sentence, like “This is the best day ever,” the model uses the extracted pitch and energy levels to ensure the synthesized voice maintains a similar level of excitement and enthusiasm. Conversely, if the initial sentence in the audio clip is delivered in a calm and low-pitched manner, such as “It's a quiet evening,” the model will predict a lower pitch and energy for the next sentence, like “Let's enjoy the tranquility,” to match the serene mood.

In some aspects, pitch may be quantified using a fundamental frequency, denoted as F0, and measured in Hertz (Hz). This fundamental frequency signifies the lowest frequency of a periodic waveform and is perceived as the pitch of the sound. For instance, a typical male speaking voice may exhibit a fundamental frequency range from approximately 85 to 180 Hz, whereas a female voice might range from 165 to 255 Hz. Additionally, pitch can sometimes be expressed in semitones relative to a reference frequency, offering a more musical representation of pitch variations.

In some aspects, energy may be represented by the amplitude of the sound wave, which correlates with the loudness of the sound and may be measured in decibels (dB). Another common measure for quantifying the energy of a signal is the Root Mean Square (RMS) Energy. This metric provides a single value that represents the average power of the waveform over a specified period, thereby offering a comprehensive measure of the signal's energy.

In some aspects, the encoder-decoder ML model is further configured to concatenate the audio clip with the upsampled representations to generate a first intermediate output, and predict the pitch for reciting the input text based on the first intermediate output. In some aspects, the encoder-decoder ML model further adds the pitch to the first intermediate output to generate a second intermediate output, and predicts the energy for reciting the input text based on the second intermediate output.

During the training phase, the masked portion of the training audio clips have target pitches and energy values. The encoder-decoder ML model is configured to minimize the difference between the target values and the predicted values using an optimization function.

At 310, the encoder-decoder ML model generates acoustic features based on (1) the duration of phoneme in the phoneme sequence, (2) the predicted pitch, and (3) the predicted energy. These acoustic features may be a Mel Spectrogram.

In some aspects, the encoder-decoder ML model adds the energy to the second intermediate output to generate a third intermediate output. The speech engine 101 specifically inputs the third intermediate output in a decoder of the encoder-decoder ML model, which generates the acoustic features.

At 312, the speech engine 101 inputs the generated acoustic features into a vocoder model.

At 314, the vocoder model generates an output waveform representing the input text being recited by the emulation of the voice. For example, the output may be a recitation of the second sentence by the voice detected in the audio clip.

FIG. 4 is a block diagram illustrating a computer system 20 on which aspects of systems and methods for emulating a voice based on a speech prompt may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-3 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for emulating a voice based on a speech prompt, comprising:
inputting, into an encoder-decoder machine learning (ML) model, an input text and an audio clip comprising a voice reciting a speech, wherein the encoder-decoder ML model is trained to generate acoustic features representing an emulation of the voice reciting the input text;
wherein the encoder-decoder ML model is configured to:
receive a phoneme sequence of the input text;
predict a duration of each phoneme in the phoneme sequence;
predict a pitch and an energy for reciting the input text based on partially masked acoustic representations obtained from the audio clip;
generate acoustic features based on (1) the duration of phoneme in the phoneme sequence, (2) the predicted pitch, and (3) the predicted energy;
inputting the generated acoustic features into a vocoder model configured to generate an output waveform representing the input text being recited by the emulation of the voice.

2. The method of claim 1, wherein the audio clip is a less than a minute in duration.

3. The method of claim 1, wherein a phoneme embedding model is configured to generate phoneme embeddings of the phoneme sequence.

4. The method of claim 3, wherein the encoder-decoder ML model is further configured to input the phoneme embeddings into an encoder of the encoder-decoder ML model, wherein the encoder is configured to:
predict the duration of the each phoneme in the phoneme sequence; and
upsample representations of individual phonemes in the phoneme embeddings based on the predicted duration.

5. The method of claim 4, wherein the encoder-decoder ML model is further configured to:
concatenate the audio clip with the upsampled representations to generate a first intermediate output; and
predict the pitch for reciting the input text based on the first intermediate output.

6. The method of claim 5, wherein the encoder-decoder ML model is further configured to:
add the pitch to the first intermediate output to generate a second intermediate output; and
predict the energy for reciting the input text based on the second intermediate output.

7. The method of claim 6, wherein the encoder-decoder ML model is further configured to:
add the energy to the second intermediate output to generate a third intermediate output; and
input the third intermediate output in a decoder of the encoder-decoder ML model, wherein the decoder generates the acoustic features.

8. The method of claim 1, wherein the encoder-decoder ML model is trained using masked and unmasked speech audio clips, wherein the encoder-decoder ML model learns to emulate a detected voice in an unmasked portion and executes an emulated voice during a masked portion.

9. A system for emulating a voice based on a speech prompt, comprising:
At least one memory; and
At least one hardware processor coupled with the at least one memory and configured, individually or in combination, to:
input, into an encoder-decoder machine learning (ML) model, an input text and an audio clip comprising a voice reciting a speech, wherein the encoder-decoder ML model is trained to generate acoustic features representing an emulation of the voice reciting the input text;
wherein the encoder-decoder ML model is configured to:
receive a phoneme sequence of the input text;
predict a duration of each phoneme in the phoneme sequence;
predict a pitch and an energy for reciting the input text based on partially masked acoustic representations obtained from the audio clip;
generate acoustic features based on (1) the duration of phoneme in the phoneme sequence, (2) the predicted pitch, and (3) the predicted energy;
input the generated acoustic features into a vocoder model configured to generate an output waveform representing the input text being recited by the emulation of the voice.

10. The system of claim 9, wherein the audio clip is a less than a minute in duration.

11. The system of claim 9, wherein a phoneme embedding model is configured to generate phoneme embeddings of the phoneme sequence.

12. The system of claim 11, wherein the encoder-decoder ML model is further configured to input the phoneme embeddings into an encoder of the encoder-decoder ML model, wherein the encoder is configured to:
predict the duration of the each phoneme in the phoneme sequence; and
upsample representations of individual phonemes in the phoneme embeddings based on the predicted duration.

13. The system of claim 12, wherein the encoder-decoder ML model is further configured to:
concatenate the audio clip with the upsampled representations to generate a first intermediate output; and
predict the pitch for reciting the input text based on the first intermediate output.

14. The system of claim 13, wherein the encoder-decoder ML model is further configured to:
add the pitch to the first intermediate output to generate a second intermediate output; and
predict the energy for reciting the input text based on the second intermediate output.

15. The system of claim 14, wherein the encoder-decoder ML model is further configured to:
add the energy to the second intermediate output to generate a third intermediate output; and
input the third intermediate output in a decoder of the encoder-decoder ML model, wherein the decoder generates the acoustic features.

16. The system of claim 9, wherein the encoder-decoder ML model is trained using masked and unmasked speech audio clips, wherein the encoder-decoder ML model learns to emulate a detected voice in an unmasked portion and executes an emulated voice during a masked portion.

17. A non-transitory computer readable medium storing thereon computer executable instructions for emulating a voice based on a speech prompt, including instructions for:
inputting, into an encoder-decoder machine learning (ML) model, an input text and an audio clip comprising a voice reciting a speech, wherein the encoder-decoder ML model is trained to generate acoustic features representing an emulation of the voice reciting the input text;
wherein the encoder-decoder ML model is configured to:
receive a phoneme sequence of the input text;
predict a duration of each phoneme in the phoneme sequence;
predict a pitch and an energy for reciting the input text based on partially masked acoustic representations obtained from the audio clip;
generate acoustic features based on (1) the duration of phoneme in the phoneme sequence, (2) the predicted pitch, and (3) the predicted energy;
inputting the generated acoustic features into a vocoder model configured to generate an output waveform representing the input text being recited by the emulation of the voice.
